(19) United States
(12) Patent Application Publication
(10) Pub. No.: US 2025/0332537 A1
(43) Pub. Date: Oct. 30, 2025

(54) SYSTEM AND METHOD FOR SAFE STORAGE, SEPARATION, AND RECYCLING OF COMPONENTS FROM EMISSIONS AND EFFLUENTS

(71) Applicant: EXPOSOME PVT. LTD., Mumbai (IN)

(72) Inventor: Prerna Goradia, Mumbai (IN)

(21) Appl. No.: 19/178,817

(22) Filed: Apr. 14, 2025

Related U.S. Application Data
(63) Continuation of application No. PCT/IN2023/050928, filed on Oct. 12, 2023.

(30) Foreign Application Priority Data
Oct. 12, 2022 (IN) 202221058221

(51) Int. Cl. B01D 53/04; B01D 53/82; B01J 20/20; B01J 20/26; B01J 20/28

(52) U.S. Cl. CPC B01D 53/0415; B01D 53/0431; B01D 53/0438; B01D 53/82; B01J 20/20; B01J 20/264; B01J 20/28019; B01J 20/28052; B01D 2253/102; B01D 2253/202; B01D 2256/26; B01D 2257/7025; B01D 2259/40088

(57) ABSTRACT

A filtering cartridge for storage and separation of gases from chamber emissions. The invention further discloses a method to separate the waste streams of gases from the effluents on the basis of physical properties such as polarity, thermal stability, molecular weight, molecular size and others. The toxic components from the effluent are safely stored and recycled, and high-pressure storage of gases is avoided and they are stored at or below atmospheric pressure.

### RELATED APPLICATIONS

This application claims priority under 35 U.S.C. § 120 to, and is a continuation of, co-pending International Application PCT/IN2023/050928, filed Oct. 12, 2023 and designating the US, which claims priority to IN application Ser. No. 20/222,1058221, filed Oct. 12, 2022, such IN Application also being claimed priority to under 35 U.S.C. § 119. These IN and International applications are incorporated by reference herein in their entireties.

### FIELD

The present invention relates generally to storage and recycling systems for various fluids. More particularly, the present invention relates to systems and methods for storing waste liquids, gases, or other fluids, separating components from a mixture for recovery of valuable molecules from waste streams and supplying the separated components from the system and methods thereof.

### BACKGROUND

In various industrial methods and applications, such as the manufacture of semiconductor materials, a reliable gaseous source consisting of gases such as chlorine, bromine, iodine, and fluorine are needed. As a result of toxicity and safety issues, many of these gases and gases containing compounds must be stored and handled carefully in industrial process equipment.

Further, cryopumping assembly in storage and delivery system apparatuses are installed where gas supplied by the storage and delivery system apparatus is desired to be furnished at high pressure in a high purity. But, the sudden opening of the high-pressure cylinders used for storage and transportation of these gases pose a serious hazard and even the risk of death to the assembler.

Thus, there is requirement of storage of these gases at reduced pressure/s to avoid any accidents. Besides, there are concerns regarding the separation and recycling of valuable components from waste streams. By lowered pressure storage, safety of the components' storage and dispensing operation will be substantially improved.

References have been made to the following prior arts:

U.S. Pat. No. 5,518,528A relates to an adsorption-desorption apparatus, for storage and dispensing of a gas selected from a group consisting of hydride gases, halide gases, and organometallic Group V gaseous compounds, wherein the gas to be dispensed is adsorbed on a physical sorbent medium and selectively dispensed by pressure differential desorption of the sorbate gas from the sorbent material. A cryopumping gas storage and delivery system is also disclosed for neat, high pressure, high purity delivery. This prior art can deal with only pure gases of hydrides etc which are simply stored and dispensed, impurities in ppm level are also not tolerated.

U.S. Pat. No. 8,858,685B2 relates to a gas storage and dispensing system with monolithic carbon adsorbent. A pyrolyzed monolith carbon physical adsorbent that is characterized by at least one of the following characteristics:
(a) a fill density measured for arsine gas at 25° C. and pressure of 650 torr that is greater than 400 grams arsine per liter of adsorbent;
(b) at least 30% of overall porosity of the adsorbent including slit-shaped pores having a size in a range of from about 0.3 to about 0.72 nanometer, and at least 20% of the overall porosity including micropores of diameter <2 nanometers; and
(c) having a bulk density of from about 0.80 to about 2.0 grams per cubic centimeter, preferably from 0.9 to 2.0 grams per cubic centimeter.

This prior art also deals with only the adsorption of certain gas and not its storage and separation from exhaust chambers.

JP5015181B2 relates to a fluid storage and dispensing system comprising a vessel for holding a fluid at a desired pressure. The vessel has a pressure regulator set at a predetermined pressure. The regulator may be interiorly or exteriorly positioned, single-staged or multi-staged, and is associated with a port of the vessel. A dispensing assembly, including a flow control means such as a valve, is arranged in gas/vapor flow communication with the regulator, whereby the opening of the valve effects dispensing of gas/vapor from the vessel. This prior art only describes the control of the flow of the gases from a storage system.

EP1569738B1 relates to a fluid storage and dispensing apparatus, comprising a fluid storage and dispensing vessel having an interior volume, wherein the interior volume contains a physical adsorbent sorptively retaining a fluid thereon and from which the fluid is desorbable for dispensing from the vessel, and a dispensing assembly coupled to the vessel for dispensing desorbed fluid from the vessel. This prior art, although containing a physical sorbent, mainly relates to storage and accurate dispensing of “a” particular fluid.

JP4279191B2 relates to a gas compound storage and delivery system. An adsorption/desorption device for boron trifluoride storage and dispensing, A storage and dispensing container configured and arranged to hold a solid phase physical sorption medium with sorption affinity for boron trifluoride and selectively allow boron trifluoride to flow into and out of the container. This prior art describes a storage and release system where a laser system utilizing a fluid as the excitatory medium for stimulated light emission, wherein the fluid is supplied from a sorbent-based fluid storage and dispensing system coupled in a fluid-supplying relationship.

It is evident that though, a variety of gas storage and dispensing apparatus are available, yet there are a few drawbacks.

There is a need for systems and method, specifically, storage and dispensing systems, which are recyclable in nature.

There is a need for systems and method, specifically, storage and dispensing systems, which are able to separate the fluids and gases on the basis of physical properties such as polarity, thermal stability, molecular weight, and others.

There is a need for systems and method, specifically, storage and dispensing systems, which provide for storage, separation, and safe recovery of gases and other valuable components from the waste streams.

There is a need for systems and method, specifically, storage and dispensing systems, where system is customizable on the basis of the input mixture and a large number of fluids can be separated.

Further, the systems of such type utilize alumina, silane and monolithic carbon sorbents as a gas storage medium, which provide high surface area and in turn resulting in greater adsorption of gases.

The information disclosed in this background of the disclosure section is only for enhancement of understanding of the general background of the invention and should not be taken as an acknowledgement or any form of suggestion that this information forms the prior art already known to a person skilled in the art.

### SUMMARY

The principal object of the present invention to provide safe storage and recycling systems for gases and effluents.

Another object of the present invention is to provide recyclable gas emission and effluent systems configured to separate the gases and components from the emissions on the basis of physical properties such as polarity, thermal stability, molecular weight, and others.

The present invention attempts to overcome problems faced in the prior art, and discloses a recyclable system to store toxic liquids, gases, or other fluid mixtures, separation of valuable components from the mixture and supplying gases and cleaner fluids from the system and method thereof.

In at least an embodiment of the present invention, the invention provides storage and dispensing systems, which are recyclable in nature. These systems are able to separate fluids (liquids, gases) on the basis of physical properties, of the fluids, the properties being polarity, thermal stability, dielectric constant, viscosity, surface tension, molecular weight, molecular size, and others.

In at least an embodiment of the present invention, the invention provides systems for storage, separation, and safe recovery of fluids and other valuable components from waste streams, where the system is customizable on the basis of input mixture and a large number of fluids can be separated by the process of the present invention.

In at least an embodiment of the present invention, the invention provides recyclable gas emission and waste water effluent systems and ability to separate gases, water, fluids on the basis of physical and/or chemical properties.

In another embodiment of the present invention, the invention provides systems and methods where toxic byproducts, from fluids, can also be separated and sent for processing.

In accordance with the embodiment of the present invention, the invention discloses methods to separate waste streams on the basis of physical properties such as polarity, thermal stability, dielectric constant, viscosity, surface tension, molecular weight, molecular size, and others.

In another embodiment of the present invention, the invention discloses systems for safe storage of emissions, where toxic gases are safely stored and recycled.

In an exemplary embodiment of the present invention, the invention discloses a system where the apparatus for separation is in the form of a cylinder or serpentine columns with loops based upon the requirements.

In another embodiment of the present invention, the invention discloses a system where the apparatus can be based on an electrostatic precipitator or bulk electrolyser with the separation process based on the charge mechanism.

In yet another embodiment of the present invention, the invention discloses a system which can be thermal and cryogenic as well based upon the properties of the gases to be stored.

In still another embodiment of the present invention, the separation process of the invention is based on the physical and chemical properties of the toxins.

In another embodiment of the present invention, the invention discloses systems where the coating of the column is selected from materials such as alumina, silica, liquid silane, monolithic carbon sorbents and combinations thereof, but not limited to.

In yet another embodiment of the present invention, the invention discloses systems where the input can be gaseous mixture or a liquid as well, based on the temperature and pressure.

In still another embodiment of the present invention, the invention discloses systems where the mobile phase for the separation of gases is selected from a group such as a carrier gas, push gas, polar mobile phase for separating non-polar mixtures and combinations thereof, based upon the requirements.

The foregoing summary is illustrative only and is not intended to be in any way limiting. In addition to the illustrative aspects, embodiments, and features described above, further aspects, embodiments, and features will become apparent by reference to the drawings and the following detailed description.

According to this invention, there is provided a system for safe storage, separation, and recycling of components from emissions and effluents, said system comprising:
a storage tank configured to elute fluids which are to be separated and/or purged;
a filtering cartridge, fluidically coupled to said storage tank, in order to receive said eluted fluids that are to be separated and/or purged,
   said filtering cartridge achieves separation and/or purging of said fluids on the basis of polarity, thermal stability, dielectric constant, viscosity, surface tension, molecular weight, molecular size,
   said filtering cartridge achieves separation and/or purging of said fluids by a process selected from a group of processes consisting of physisorption process and chemisorption process, in that, said filtering cartridge comprising:
   a hollow tubular casing having an inlet to receive the fluids for separation and an outlet for egress of separated fluids with a molecular filter therebetween, said molecular filter configuring a fluid flow path such that said eluted fluids pass through said molecular filter, said molecular filter consisting of at least a substrate and at least a defined pathway, lined with said substrate, in order for said fluid to pass through said defined pathway while, simultaneously, reacting with said substrate, order to cause said separation, said molecular filter being selected from a group of molecular filters consisting of:
   a spiral pipe packed with a substrate,
   a block with a substrate having a plurality of internal tortuous paths,
   a plurality of stacked porous substrate blocks,
   a plurality of spherical substrate beads, and
   a porous substrate block.

In at least an embodiment, said filtering cartridge's inlet and said filtering cartridge's outlet are co-axial with a hollow therebetween.

In at least an embodiment, said spiral pipe packed with a substrate having an internal flow path, for fluid flow, configured in a direction extending between said inlet and said outlet.

In at least an embodiment, said block of substrate having an internal flow path, for fluid flow, configured in a direction extending between said inlet and said outlet.

In at least an embodiment, said plurality of stacked porous substrate blocks having an internal flow path, for fluid flow, configured in a direction extending between said inlet and said outlet.

In at least an embodiment, said plurality of spherical substrate beads having an internal flow path, for fluid flow, configured in a direction extending between said inlet and said outlet.

In at least an embodiment, said a porous substrate block having an internal flow path, for fluid flow, configured in a direction extending between said inlet and said outlet.

In at least an embodiment, said substrate including at least one of ceramic, carbon, polymer, and/or combinations thereof, said substrate has a pre-defined pore size ranging between 1 to 60 Å, said pore size being sufficient to allow entry of molecules of fluids to be separated.

In at least an embodiment, said substrate being extruded ceramic matrices and/or carbon blocks.

In at least an embodiment, said system comprising a negative pressure applicator fluidically coupled to said filtering cartridge.

In at least an embodiment, said system comprising a carrier gas applicator from which gas is introduced from a pressurized cylinder and is flow controlled using mass flow controllers.

In at least an embodiment, said substrate having adsorbent layers of same or different materials packed in a column or a spiral tube filled with selected adsorbents where the fluids flow in and out.

In at least an embodiment, in order to achieve physisorption, said filtering cartridge being jacketed by a heat exchanger, thereby controlling temperature of the molecular filters and, optionally, being connected to a vacuum pump to adjust pressure that enhances fluid separation, in that, said gases, selectively, adsorb on the molecular filters at low temperatures and desorb at higher temperatures; and-said gases desorb with change in pressure or with increase in negative pressure at the outlet.

In at least an embodiment, in order to achieve chemisorption, said filtering cartridge includes an active molecule infused on the molecular filter to help with chemisorption reactions for separation of the gases, said active molecule adapted to undergo chemisorption type of reactions with the unwanted emission gases to enable recycling of the remaining unadsorbed gas.

In at least an embodiment, a carrier gas applicator is fluidically coupled to said filtering cartridge, in that, said molecular filters being polar in nature and said carried gas being non-polar in nature.

In at least an embodiment, said substrate is at least one of inorganic metallic oxide, nitride, carbide material, carbon, polymeric materials, metal oxides such as zeolites and alumina beads or advanced carbon materials or polymeric materials such as polyacrylate-polyalcohol beads, polydimethyl siloxane beads, poly (methyl methacrylate) microspheres (PMMA), divinyl benzene beads, polyethylene glycol granular or polyethylene glycol (PEG), and combinations thereof.

In at least an embodiment, in order to achieve chemisorption, said filtering cartridge (600) includes an active molecule infused on the molecular filter to help with chemisorption reactions for separation of the gases, said active molecule adapted to undergo chemisorption type of reactions with the emissions to enable recycling of un-adsorbed gas, in that, said active molecule, is at least one of thiosulphates, oxidizers such as permanganates, phosphoric acid, ferrous sulphate, metal hydroxides, iodides, bicarbonates, amines and certain metal oxides such as calcium oxide, and combinations thereof.

In at least an embodiment, said substrate being filled into a spiral pipe running between the inlet and the outlet, said spiral pipes or channels allowing maximum flow path of said fluid for separation; and said substrate being solid packed or lined liquid and porous matrices.

In at least an embodiment, said substrate being in the form of a block having a plurality of internal tortuous hollow paths configured there within, each of the tortuous paths being configured as longitudinal channels consisting of different connected but staggered sections to configure a plurality of parallel running gas flow paths; and each staggered section being connected to a section preceding it and to a section succeeding it.

In at least an embodiment, said substrate comprising a plurality of porous substrate blocks that are stacked over each other and adapted to be positioned in a stacked manner within said hollow casing; and a gas flow path being configured by pores in each of the porous substrate blocks that interconnect once the blocks are stacked over each other extending between the inlet and the outlet of the hollow casing.

In at least an embodiment, said substrate being configured in the form of a plurality of spherical beads that are filled in the hollow casing to extend between the inlet and the outlet, said beads having a high surface area and being made of ceramic and/or carbon in different sizes to enhance packing density and functions for storage and separation of fluids.

In at least an embodiment, said substrate being a porous substrate block that has internal hollow channels configured therewithin to enable passage of gases therethrough, said porous substrate block being adapted to be positioned within the hollow casing such that the internal hollow channels extend in the direction running from the inlet to the outlet such that gases entering through the inlet enters the internal hollow channels where the adsorption process happens as the gas moves towards the outlet.

### BRIEF DESCRIPTION OF THE ACCOMPANYING DRAWINGS

It is to be noted, however, that the appended drawings illustrate only typical embodiments of the present invention and are therefore not to be considered for limiting of its scope, for the invention may admit to other equally effective embodiments. The detailed description is described with reference to the accompanying figures. In the figures, the left-most digit(s) of a reference number identifies the figure in which the reference number first appears. The same numbers are used throughout the figures to reference like features and components. Some embodiments of system or methods in accordance with embodiments of the present invention are now described, by way of example, and with reference to the accompanying figures, in which:

FIG. 1 illustrates a diagrammatic view of the gas storage and recycling system for separation of process-gas outflows and purification, in accordance with an embodiment of the present invention;

FIG. 2 illustrates a flow diagram of the method and using the gas storage and recycling system, of FIG. 1, in accordance with an embodiment of the present invention;

FIG. 3 illustrates a variation of products in the storage and separation tank/chamber having adsorbent layers of same or different materials packed in a column or a spiral tube filled with selected adsorbents where the gases flow in and out; and

FIG. 3a, FIG. 3b, FIG. 3c, FIG. 3d, and FIG. 3e illustrate different embodiments of a substrate in a filtering cartridge of the system of FIG. 3.

The figure depicts embodiments of the present invention for the purposes of illustration only. A person skilled in the art will easily recognize from the following description that alternative embodiments of the structures and methods illustrated herein may be employed without departing from the principles of the disclosure described herein.

### DETAILED DESCRIPTION

While the embodiments of the disclosure are subject to various modifications and alternative forms, specific embodiments thereof have been shown by way of example in the figures and will be described below. It should be understood, however, that it is not intended to limit the disclosure to the particular forms disclosed, but on the contrary, the disclosure is intended to cover all modifications, equivalents, and alternatives falling within the scope of the disclosure. Further, the phraseology and terminology employed in the description is for the purpose of description only and not for the purpose of limitation.

The terms “comprises”, “comprising”, or any other variations thereof used in the disclosure, are intended to cover a non-exclusive inclusion, such that a device, apparatus, system, assembly, method that comprises a list of components or a series of steps that does not include only those components or steps but may include other components or steps not expressly listed or inherent to such apparatus, or assembly, or device. In other words, one or more elements or steps in a system or device or process proceeded by “comprises . . . a” or “comprising. . . . Of” does not, without more constraints, preclude the existence of other elements or additional elements or additional steps in the system or device or process as the case may be.

According to this invention, there are provided systems and methods for safe storage, separation, and recycling of components from emissions and effluents. A primary object, of the present, invention is to provide recyclable systems and methods to store toxic liquids, gases, and/or fluid mixtures, separation of the liquids, gases, and/or fluids from the mixture, and supplying liquids, gases, and/or fluids from the system and method thereof.

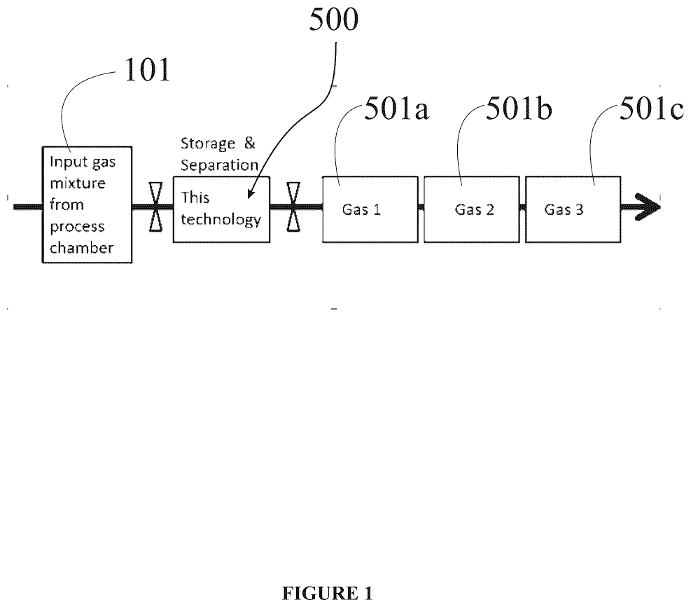

Reference may be made to FIG. 1 illustrating a diagrammatic view of the gas storage and recycling system for separation of process-gas outflows and purification, in accordance with an embodiment of the present invention.

STEP 101: Input fluid mixture is derived from process chamber.

STEP 500: In the process, a mixture of unused process fluids and by-products are eluted from a storage and separation chamber. The chamber can be in the form of a cylinder or spiral tubular assembly (500a), where toxins are temporarily “concentrated” into the cylinder or the spiral tubular assembly and the “filtered gases or effluents” are sent for reuse or discharge. Once the toxins have been concentrated up to predetermined thresholds, then either a negative pressure (500b) is applied and/or elevated temperature is applied to the cylinder or the spiral tubular assembly. Alternatively, an appropriate push gas eluant (500c) is introduced.

STEP 501a, 501b, 501c: The toxins and/or the unused process molecules, upon detection by a detector (500d), come out in “chunks” or “blocks” which can be sent back into the system or is, further, stored under near-atmospheric pressure chambers. In these atmospheric pressure chambers, main interactions are adsorption, absorption, and selective elution.

FIG. 1 illustrates the gas storage and recycling system, in accordance with an embodiment of the present invention

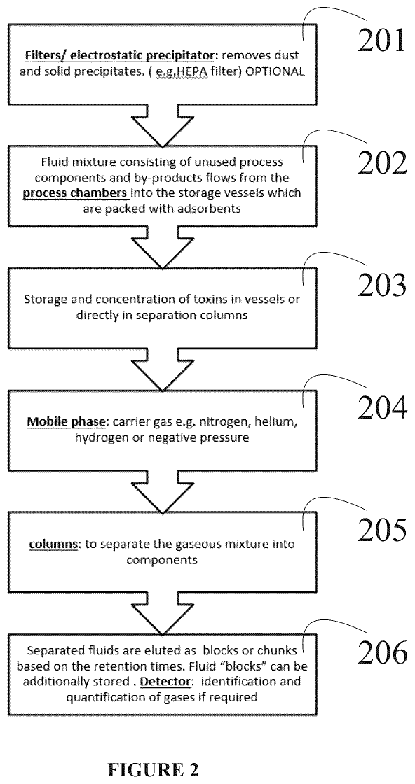

FIG. 2 illustrates a flow diagram of the method and using the gas storage and recycling system, of FIG. 1, in accordance with an embodiment of the present invention.

In an embodiment, the invention discloses a system, and method, where, as per STEP 201, air filters or electrostatic precipitators such as HEPA filters are installed to remove the dust and solid precipitates.

Further, as per STEP 202, the effluent mixture consisting of unused process gases and by-products, flows from the process chambers (500a) into the storage tanks.

As per STEP 203, in the storage tanks, the storage is in the form of chambers or directly in the columns.

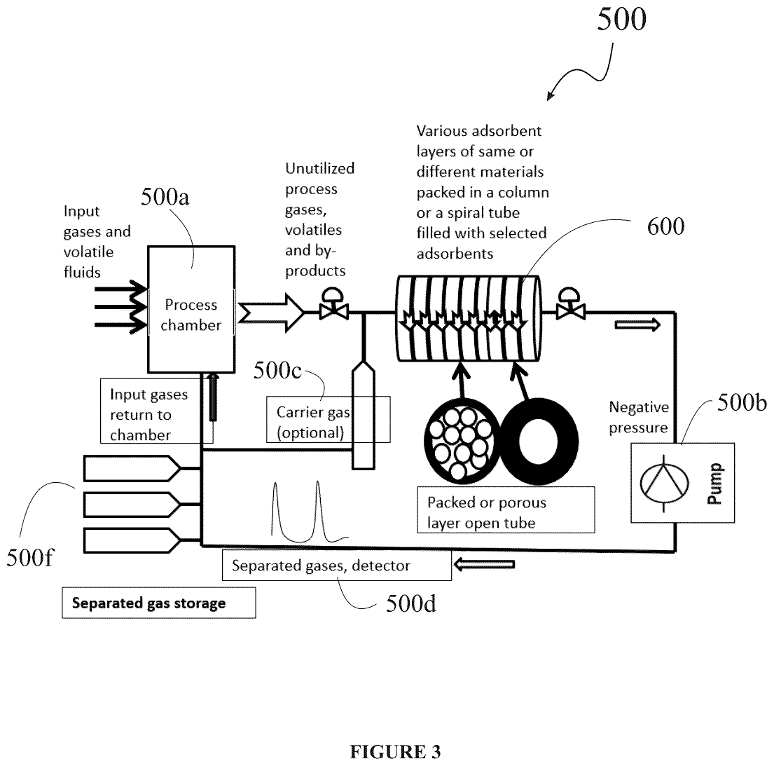

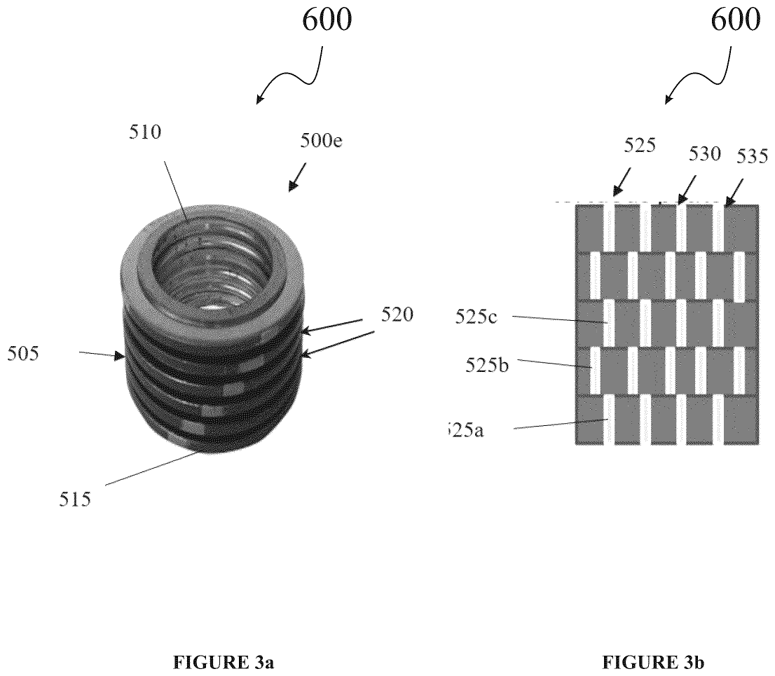

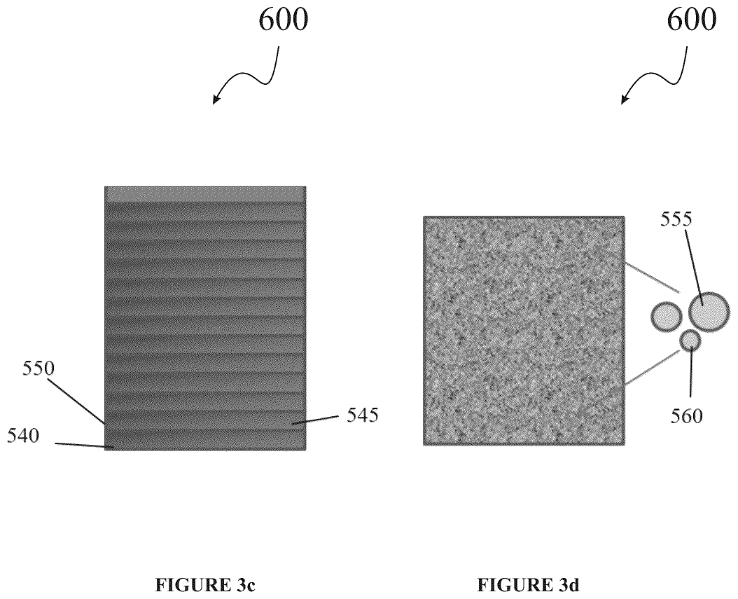

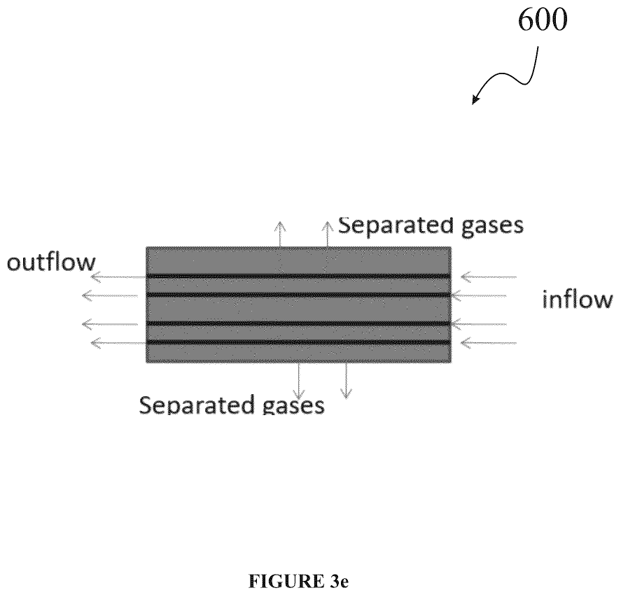

As shown in FIG. 3, a filtering cartridge (600) is fluidically coupled to a storage tank in order to receive the mixture of fluids that are to be separated. The filtering cartridge (600), which forms the inventive concept of the present invention, is described, further, in the ensuing paragraphs. Further, as shown in FIG. 3, the gaseous mixture in the emissions is separated in the filtering cartridge (600) where separation is on the basis of changes in polarity, thermal stability, dielectric constant, viscosity, surface tension, molecular weight, molecular size, and other properties of fluids by the process of physisorption or chemisorption depending upon the types of fluids in the emissions to be separated. The fluids, after separation, are stored in the storage tank or external cylinders (500f) for further usage or are sent back in to the process chamber.

In another embodiment, as per STEP 204, the mobile phase for the separation of gases is selected from a group such as a carrier gas, push gas, polar mobile phase for separating non-polar and polar mixtures and combinations thereof, based upon the requirements. The volume of carrier gas that will purge an analyte through one gram of adsorbent at a specific temperature is termed as the breakthrough volume. Breakthrough volume data is important in order to assure that the analytes of interest are not purged off the storage bed during toxin collection but only during the dispensing.

In an embodiment, the separation for the effluents is based on the change in temperature. With the increase in temperature, the physical and chemical properties of water make it conducive for the separation of dissolved and dispersed components.

In an embodiment, separation is on the basis of changes in the polarity, dielectric constant, viscosity, surface tension and many other properties. The solubility of analytes, which at room temperature may be insoluble in such a strongly polar solvent, also changes.

In an embodiment, the storage media must have appropriate properties, such as aqueous stability, thermal stability and selectivity in relation to mixtures of compounds of different polarity.

In an embodiment, a number of the storage and separation media based on silica, carbon, polymers or metal oxides may be used in the process of the present invention.

STEP 205: In an embodiment, separator columns are used to separate gaseous mixture into components.

STEP 206: In an embodiment, separated fluids are eluted as “chunks” or “blocks” based on retention times. Fluid “blocks” can be, additionally, stored. A detector (500d) is employed for identification and quantification of gases, if required.

FIG. 3a, 3b, 3c, 3d, 3e illustrates different embodiments of a substrate in a filtering cartridge of the system of FIG. 3.

Reference may be made to FIG. 3 illustrating the variation of products in the storage and separation tank/chamber having adsorbent layers of same or different materials packed in a column or a spiral tube filled with selected adsorbents where the gases flow in and out.

The adsorbents may be packed in bulk or coated onto the columns.
a) Extruded ceramic and or carbon block components with tortuous paths in the storage and separation tank/chamber. The fluids are forced to pass through the ceramic matrices and get adsorbed and retained by the ceramic blocks. By this construct the path lengths of the incoming fluids are drastically increased and the retention time of the eluents can be optimized. The higher molecular weight components along with the covalently linked ones take longer to elute once the push gas or negative pressure is applied. The special construction allows the maximum retention and concentration of the gases on a chamber with lower overall volume. Similarly, the molecules may be separated on the basis of the pore size as well.
b) Spiral (hollow or solid) pipes or channels to allow maximum flow path of the gas mixtures for separation in the tank/chamber. Here the idea is that the hollow and solid pipes are packed or lined with the adsorbents which help in the separation of the gas components. By making them spiral the overall volume and space required to house the chamber is managed. As the fluid mixture passes through the forced long path length through solid packed or lined liquid and porous matrices, the pollutants get effectively adsorbed, concentrated and separated
c) Thin porous carbon and or ceramic stacked blocks that store and separate the gases in the tank/chamber. Here since the materials are stacked in thin strips and they can be of the same or different materials they allow for a good partition of the fluids on the interfaces and the solid blocks. The fluid streams benefit from the interfaces where the maximum adsorption can take place on edge sites and the materials of construction since they are various can be customized to separate and store the gas streams.
d) Block filled with high surface area ceramic and carbon spheres of different sizes to enhance the packing density and function as a storage and separation tank/chamber. The spaces in between the spheres along with the faces of the spheres yield very high portioning of the fluids yielding an efficient separation. These act as the active sites for the chemisorption of fluids at lower temperature which is liberated by temperature programmed desorption at elevated temperatures for example. The material is capable of adsorbing >10 STP cm 3 of dry CO₂ per gram and can be regenerated upon heating. It might be used as scrubber for carbon dioxide from industrial gaseous streams just as an example.

Porous Block with flow paths for gases with the influent and effluent gas path defined in the storage and separation tank/chamber where the pollutants are trapped in the ceramic layers where adsorption takes place and the purified fluids are collected from the outer walls of the chamber. This is a very unique design where the fluids are pushed using pressure through the blocks and in turn get concentrated and separated. The process can also be modulated by the temperature in addition to the pressure. Also, the separation could be using liquids where the important molecules in the present invention can be separated from the effluents, which may require an increase in temperature of the water where the decrease of water polarity would take place and this may further yield tunable parameters such as dielectric constant, surface tension and viscosity as described further.

The filtering cartridge (600) will now be described in detail in conjunction with FIGS. 3(a) to 3€ of the accompanying drawings. The present invention envisages that the filtering cartridge (600) includes a hollow tubular casing (505) having an inlet (510) to receive the fluids for separation and an outlet (515) for egress of separated fluids, in accordance with an embodiment of the present invention as shown in FIG. 3(a). The inlet (510) and the outlet (515) are co-axial with a hollow therebetween. The filtering cartridge (600), additionally, includes at least one molecular filter (600) positioned within the hollow tubular casing (505) between the inlet (510) and the outlet (515) and configuring a gas flow path therewithin; through the at least one molecular filter (600). Different configurations, of gas flow paths, are envisaged and as per different embodiments, of the molecular filter (600), the gas flow path could be configured as one of the following:
a spiral pipe packed with substrate (shown in FIG. 3(a)),
a block of substrate having a plurality of internal tortuous paths (shown in FIG. 3(b)),
plurality of stacked porous substrate blocks (shown in FIG. 3€),
a plurality of spherical substrate beads (shown in FIG. 3(d)), and
a porous substrate block (shown in FIG. 3€), each having an internal flow path configured in the direction extending between the inlet (510) and the outlet (515).

The below table describes the rationale for each of them:

TABLE 1

| | |
|---|---|
| FIG. 3a.: Spiral tube | This allows a long path length for the |
| with the adsorbents | flow of gases enhancing the difference in |
| packed in or coated | retention times amongst the gases |
| FIG. 3b.: Representation | Allows the filtration of bulky molecules |
| of stacked blocks with | |
| misaligned pores | |
| FIG. 3c. Extruded blocks | Allows dense packing of adsorbents |
| of adsorbents | especially for chemisorptive adsorption |
| | in which the weight of gas per gram of |
| | the adsorbent is constant. |
| FIG. 3d.: Packing of | Mainly for physisorption of gases and |
| granular media with | separation based on physical properties |
| definite pore size | |
| and composition | |
| FIG. 3e.: Laminar flow | The separation of small molecules in the |
| filter which allows | perpendicular direction takes place |
| efficient removal of | |
| small molecules | |

Typically, the molecular filter (600) is made of a high surface area substrate including at least one of ceramic, carbon, polymer, and/or combinations thereof and the substrate has a pre-defined pore size.

In at least an embodiment of the present invention, the pre-defined pore size is sufficient to allow the entry of molecules of gases to be separated. Further, the pore size ranges between 1 to 60 Å. Further, the substrate in the molecular filter is extruded ceramic and or carbon block component configured with flow paths, which may be tortuous and/or lengthy so that the fluids are forced to pass through the ceramic matrices and get adsorbed and retained by the ceramic blocks. By this construct, the path lengths of the incoming fluids are drastically increased and the retention time of the effluents can be optimized. The higher molecular weight components along with the covalently linked ones take longer to elute once the push gas or negative pressure is applied. The special construction allows the maximum retention and concentration of the gases on a chamber with lower overall volume. Similarly, the molecules may be separated on the basis of the pore size as well.

In at least an embodiment of the present invention, the molecular filter in the filtering cartridge has adsorbent layers of same or different materials packed in a column or a spiral tube filled with selected adsorbents where the gases flow in and out. The adsorbents may be packed in bulk or coated onto the columns.

As explained earlier, the aim of configuring the gas flow path is to provide a lengthy path for the gases to flow through for interaction with different adsorption media to enable separation of the gases. As would be evident from the different embodiments, the gas flow path could be tortuous (FIG. 3b), spiral (FIG. 3a), or consisting of multiple adsorption layers (FIG. 3c); in order to enable effective absorption.

In an embodiment of the present invention, the adsorption process for the separation of gases is physisorption or chemisorption depending upon the types of gases in the emissions to be separated.

For separation by physisorption process, the cartridge is jacketed by a heat exchanger, thereby controlling the temperature of the molecular filters and optionally connected to a vacuum pump to adjust the pressure that allows the gases to be separated. Generally, the gases selectively adsorb on the molecular filters at low temperatures and desorb at higher temperatures. Similarly, they tend to desorb with change in pressure or with increase in negative pressure at the outlet.

For separation by chemisorption process, the filtering cartridge (600), optionally, includes an active molecule infused on the molecular filter (600) to help with chemisorption reactions for separation of the gases. The active molecule is adapted to undergo chemisorption type of reactions with the emissions to enable recycling of un-adsorbed gas back into the process chamber.

Typically, a carrier gas applicator (500c) is fluidically coupled to said filtering cartridge (600). The carrier gas improves desorption of adsorbed component. The molecular filters could be polar and the carrier gas (if used) nonpolar. Here the polar molecules from the emissions are eluted last as they bond better with the molecular filters. If the molecular filters are nonpolar and the carrier gas (if used) is polar the non-polar (hydrophobic) molecules tend to adsorb to the molecular filters and polar gas molecules are eluted first.

In an embodiment of the present invention, the hollow casing is made from an inert material usually of stainless steel, fibre-reinforced composite, plastic, and combinations thereof. For certain corrosive gases such as fluorine containing the plastic or FRC lining may be done on the cartridge.

Moreover, in another embodiment of the present invention, the substrate in the molecular filter (600) is at least one of inorganic metallic oxide, nitride, carbide material, carbon, polymeric materials, metal oxides such as zeolites and alumina beads or advanced carbon materials or polymeric materials such as polyacrylate-polyalcohol beads, polydimethyl siloxane beads, poly (methyl methacrylate) microspheres (PMMA), divinyl benzene beads, polyethylene glycol granular or polyethylene glycol (PEG) and combinations thereof.

In yet another embodiment of the present invention, the active molecule, infused on the molecular filter (600), is at least one of thiosulphates, oxidizers such as permanganates, phosphoric acid, ferrous sulphate, metal hydroxides, iodides, bicarbonates, amines and certain metal oxides such as calcium oxide and combinations thereof.

The present invention envisages that the length of the gas flow path is selectively variable as per the requirement for separation of gases. This means that depending on the type of gases to be separated, the substrate in the molecular filter could be selected from the various described options.

In particular, as shown in FIG. 3(a), the substrate could be filled into spiral pipe (520) running between the inlet (510) and the outlet (515). The spiral pipes or channels allow maximum flow path of the gas mixtures for separation of gases. The hollow and solid pipes are packed or lined with the adsorbents which help in the separation of the gas components. The advantage of using spiral pipes is that the overall volume and space required to house the chamber is managed. As the fluid mixture passes through the forced long path length through solid packed or lined liquid and porous matrices, the pollutants get effectively adsorbed, concentrated, and separated. The filling and packing of the substrate within the spiral pipes may be done in a manner that there is unrestrictive flow of the gaseous mixture through the spiral pipe. As the effluent or mixture of gases passes through the spiral pipe, it interacts with the substrate filled therein to be adsorbed.

In particular, as shown in FIG. 3(b), the substrate is in the form of a block (523) that has plurality of internal tortuous hollow paths (525, 530, 535) configured therewithin. Each of the tortuous paths (525, 530, 535) are configured as longitudinal channels consisting of different connected but staggered sections (525a, 525b, 525c) to configure plurality of parallel running gas flow paths. Each staggered section (525a, 525b, 525c) is connected to the section preceding it and succeeding it. For instance, a first staggered section (525b) is connected to a second preceding staggered section (525a) and to a third succeeding staggered section (525c). Further, the block 523 is adapted to be placed within the hollow casing (505) in a manner such that each of the tortuous paths (525, 530, 535) extend from the inlet (510) towards the outlet (515) such that once the gas mixture enters the inlet (510), it passes through the staggered sections of each of the tortuous hollow paths (525, 530, 535) to interact with the substrate material and effectuate the process of adsorption.

In particular, as shown in FIG. 3(c), the gas flow path could be configured using a plurality of porous substrate blocks (540, 545, 550) that are stacked over each other and adapted to be positioned in the stacked manner within the hollow casing (505). The gas flow path, in this embodiment, is configured by the pores in each of the porous substrate blocks (540, 545, 550) that interconnect once the blocks are stacked over each other extending between the inlet (510) and the outlet (515) of the hollow casing (505). In an embodiment, the substrate blocks (540, 545, 550) could be of porous carbon and/or ceramic and the substrate is stacked in thin strips and that can be of the same or different materials to allow for a good partition of the fluids on the interfaces and the solid blocks. The fluid streams benefit from the interfaces where the maximum adsorption can take place on edge sites and the materials of construction since they are various can be customized to separate and store the gas streams.

In particular, as shown in FIG. 3(d), the substrate is configured in the form of a plurality of spherical beads (555, 560) that are filled in the hollow casing (505) to extend between the inlet (510) and the outlet (515). The beads (555, 560) may have high surface area and made of ceramic and/or carbon in different sizes to enhance the packing density and functions for storage and separation of gases. The spaces in between the spheres along with the faces of the spheres yield very high portioning of the fluids yielding an efficient separation. These act as the active sites for the chemisorption of fluids at lower temperature which is liberated by temperature programmed desorption at elevated temperatures. For example, the molecular filter is capable of adsorbing >10 STP cm3 of dry CO2 per gram and can be regenerated upon heating. It might be used as scrubber for carbon dioxide from industrial gaseous streams

In particular, as shown in FIG. 3(e), the gas flow path may be configured using another porous substrate block (565) that has internal hollow channels (570, 575) configured therewithin to enable passage of gases therethrough. The porous substrate block (565) is adapted to be positioned within the hollow casing (505) such that the internal hollow channels (570, 575) extend in the direction running from the inlet (510) to the outlet (515) such that gases entering through the inlet (505) enters the internal hollow channels (570, 575) where the adsorption process happens as the gas moves towards the outlet (515). The substrate block could be made of ceramic such that the pollutants are trapped in the ceramic layers where adsorption takes place and the purified fluids are collected from the outer walls of the chamber. This is a very unique design where the fluids are pushed using pressure through the blocks and in turn get concentrated and separated.

In an embodiment in the method implemented in the said system for enabling separation of gases, air filters or electrostatic precipitators such as HEPA filters are installed to remove the dust and solid precipitates. Further, the effluent mixture consisting of unused process gases and by-products, flows from the process chambers (500a) into the storage tanks. In the storage tanks, the storage is in the form of chambers or directly in the columns. A filtering cartridge (600) which is fluidically coupled to the storage tank receives the mixture of gases to be separated through the inlet (510). Further, the gaseous mixture in the emissions is separated through the molecular filter of the filtering cartridge where the separation is on the basis of changes in the polarity, dielectric constant, viscosity, surface tension and other properties of gases by the process of physisorption or chemisorption depending upon the types of gases in the emissions to be separated. The molecular filter in the filtering cartridge has adsorbent layers of same or different materials packed in a column or a spiral tube filled with selected adsorbents where the gases flow in and out. The adsorbents may be packed in bulk or coated onto the columns. The gases after separation are stored in the storage tank or elution is through the outlet (515) and stored in external cylinders (115) for further usage or are sent back in to the process chamber.

In an embodiment the storage and separation chamber in the system may have different combinations for the separation and storage of gases as per the requirements.

In an embodiment of the present invention, the invention relates to provide recyclable fluid systems with the ability to separate the toxins on the basis of physical properties. The important molecules in the present invention can be separated from the effluents, which may require an increase in temperature of the water where the decrease of water polarity would take place and this may further yield tunable parameters such as dielectric constant, surface tension and viscosity, which decrease with increase of water temperature yielding better separation.

In accordance with the embodiment of the present invention, the invention discloses a method to separate the gases on the basis of physical properties of the gases such as polarity, thermal stability, molecular weight, and others.

In accordance with the embodiment of the present invention, the invention discloses a system for safe storage of emissions, where toxic components are safely stored and recycled. The high-pressure storage of gases is avoided and they are stored at or below atmospheric pressure.

In an exemplary embodiment of the present invention, the invention discloses a system where the apparatus for separation is in the form of a cylinder or serpentine columns with loops based upon the requirements.

In accordance with the embodiment of the present invention, the invention discloses a system where the entry apparatus can be on the basis of an electrostatic precipitator or bulk electrolyser with the separation process based on the charge separation mechanism.

In accordance with the embodiment of the present invention, the invention discloses a system which can be thermal and cryogenic as well based upon the properties of the gases to be stored.

In accordance with the embodiment of the present invention, the separation process of the invention is based on the physical and chemical properties.

In accordance with the embodiment of the present invention, the invention provides systems for safe storage of emissions, separation and dispersal of gases and fluids, where the system is customizable on the basis of the input mixture and a large number of gases can be separated by the process of the present invention.

In accordance with the embodiment of the present invention, the invention discloses systems where the coating of the column is selected from materials such as alumina, silica, liquid silane, monolithic carbon sorbents, molecular sieves and combinations thereof, but not limited to.

In accordance with the embodiment of the present invention, the invention discloses systems where the input can be gaseous mixture or liquid as well, based on the temperature and pressure.

In accordance with the embodiment of the present invention, the invention discloses a method where the mobile phase for the separation of gases is selected from a group such as a carrier gas, push gas, polar mobile phase for separating non-polar and polar mixtures and combinations thereof, based upon the requirements.

In an embodiment, the separation is based on an increase in temperature as with the increase in temperature the physical and chemical properties of water make it conducive for the separation of dissolved and dispersed components.

In an embodiment, the separation is based on the changes in its polarity, dielectric constant, viscosity, surface tension and many other properties. The solubility of analytes, which at room temperature may be insoluble in such a strongly polar solvent, also changes.

In an embodiment, the storage media must have appropriate properties, such as aqueous stability, thermal stability and selectivity in relation to mixtures of compounds of different polarity.

In an embodiment, a number of the storage and separation media based on silica, carbon, polymers or metal oxides may be used.

In an embodiment, some additions to the mobile phase in the form of acids or pH-regulating compounds may help in the selective separation and recycling of the components (FIGS. 1 and 2).

The volume of carrier gas that will purge an analyte through one gram of adsorbent at a specific temperature is termed as the breakthrough volume. Breakthrough volume data is important in order to assure that the analytes of interest are not purged off the storage bed during toxin collection but only during the dispensing. This data can also be used to purge off lighter volatiles such as solvent that get introduced into the adsorbent.

Example 1: In a system, where the breakthrough volume is 1.0 liter per gram, then the toxin should not be purged with more than 500 mL of gas during storage. In summary breakthrough volume is defined as the calculated volume of carrier gas per gram of adsorbent resin which causes the analyte molecules to migrate from the front of the adsorbent bed to the back of the adsorbent bed.

The term ‘breakthrough volume’ has also been referred to as retention volume and also the specific retention volume. The units of breakthrough volume are usually expressed as liters/gram. The retention time depends on the system parameters but just as an example the retention time of a gas mixture is listed here to showcase how the separation can take place with different compounds depending on their polarity (Table 2).

TABLE 2
Retention time of different gases

| Compound | Approximate Retention | |
|---|---|---|
| methane | 2 | min |
| Cyclopropane | 9 | min |
| 1 - butene | 14 | min |
| n-pentane | 19 | min |
| n-hexane | 20 | min |

In the above filter, the filter of type 3c was used where the extruded blocks of advanced carbon adsorbents were used. The extruded blocks of advanced carbon materials allowed the hydrocarbons which were lighter to be eluted faster than the bulkier ones.

Example 2. In another example of filter 3d. where the granular adsorbents are used consisting of polymers of Poly (styrene-co-divinylbenzene) where the separation of molecules on the basis of hydrophobic interactions takes place. The experiment that was run to obtain pure fluorine gas where small amount of metal and organic impurities had to be removed.

TECHNICAL ADVANTAGES: In accordance with advantages of the present invention as compared with the existing scrubbers, the present invention is to provide a big change in the field of safe storage of emissions and separation of gases from the mixture. The invention comprises of storage chambers with the coating material having high surface area, selected from a group of activated carbon, silica, alumina and other metal oxides and combinations thereof for safe storage and minimum wastage. The substrates may be coated with active materials such as inorganic salts based on the selective removal of fluids. Further, the gases in the process chambers are very expensive and in turn gets wasted, which can be recovered using the system of the present invention and wastage issue can be addressed. Besides, carbon can be added to give mechanical stability to the material. The advantage of the present invention: To capture unutilized process gases and by-products to refine the effluents into pure process gases that can be reused, for lowering emissions.

The TECHNICAL ADVANCEMENT, of this invention, lies in: The present invention provides storage and dispensing systems, which are recyclable in nature. These systems are able to separate the fluids and gases on the basis of physical properties such as polarity, thermal stability, molecular weight, and others.

Thus, the invention provides systems for storage, separation, and safe recovery of gases and other valuable components from the waste streams, where the system is customizable on the basis of the input mixture and a large number of fluids can be separated by the process of the present invention.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible.

In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

Although embodiments for the present invention have been described in language specific to structural features, it is to be understood that the present invention is not necessarily limited to the specific features described. Rather, the specific features and methods are disclosed as embodiments for the present invention. Numerous modifications and adaptations of the system/component of the present invention will be apparent to those skilled in the art, and thus it is intended by the appended claims to cover all such modifications and adaptations which fall within the scope of the present invention.

1. A system for safe storage, separation, and recycling of components from emissions and effluents, the system comprising:
a storage tank configured to elute fluids which are to be separated and/or purged; and
a filtering cartridge fluidically coupled to the storage tank to receive the eluted fluids that are to be separated and/or purged, wherein the filtering cartridge includes,
a hollow tubular casing having an inlet to receive the fluids for separation,
an outlet for egress of separated fluids,
a molecular filter between the inlet and the outlet, wherein the molecular filter defines a fluid flow path such that the eluted fluids pass through the molecular filter, and wherein the molecular filter includes a substrate lining a pathway through which the fluid passes while reacting with the substrate to cause the separation, and wherein the molecular filter includes at least one of,
a spiral pipe packed with a substrate,
a block with a substrate having a plurality of internal tortuous paths,
a plurality of stacked porous substrate blocks,
a plurality of spherical substrate beads, and
a porous substrate block, wherein the filtering cartridge achieves separation and/or purging of the fluids on the basis of polarity, thermal stability, dielectric constant, viscosity, surface tension, molecular weight, and molecular size using at least one of a physisorption process and a chemisorption process.

2. The system of claim 1, wherein the inlet and the filtering outlet are co-axial with a hollow between the inlet and the outlet.

3. The system of claim 1, wherein the molecular filter includes the spiral pipe packed with the substrate, and wherein the substrate has an internal flow path for fluid flow proceeding in a direction extending between the inlet and the outlet.

4. The system of claim 1, wherein the molecular filter includes the block of substrate, and wherein the substrate has an internal flow path for fluid flow proceeding in a direction extending between the inlet and the outlet.

5. The system of claim 1, wherein the molecular filter includes the plurality of stacked porous substrate blocks, and wherein the substrate blocks have an internal flow path for fluid flow proceeding in a direction extending between the inlet and the outlet.

6. The system of claim 1, wherein the molecular filter includes the plurality of spherical substrate beads, and wherein the substrate beads have an internal flow path for fluid flow proceeding in a direction extending between the inlet and the outlet.

7. The system of claim 1, wherein the molecular filter includes the porous substrate block, and wherein the substrate block has an internal flow path for fluid flow proceeding in a direction extending between the inlet and the outlet.

8. The system of claim 1, wherein the substrate includes at least one of, extruded ceramic matrices, carbon blocks, and a polymer, and wherein the substrate has a pre-defined pore size ranging between 1 to 60 Å sufficient to allow entry of molecules of the fluids to be separated.

9. The system of claim 1, further comprising:
a negative pressure applicator fluidically coupled to the filtering cartridge.

10. The system of claim 1, the system further comprising:
a carrier gas applicator from which gas is introduced from a pressurized cylinder and is flow controlled using mass flow controllers.

11. The system of claim 1, wherein the substrate has adsorbent layers of materials packed in a column or a spiral tube filled with adsorbents where the fluids flow in and out.

12. The system of claim 1, wherein the filtering cartridge achieves separation and/or purging of the fluids using the physisorption process by jacketing the filtering cartridge with a heat exchanger so as to control a temperature of the molecular filters and the gases selectively adsorb on the molecular filters at low temperatures and desorb at higher temperatures and the gases desorb with a change in pressure or with an increase in negative pressure at the outlet.

13. The system of claim 1, further comprising:
a carrier gas applicator fluidically coupled to the filtering cartridge, wherein the molecular filters are polar and the carried gas is non-polar.

14. The system of claim 1, wherein the substrate is at least one of, an inorganic metallic oxide, nitride, carbide material, carbon, polymeric materials, and metal oxides.

15. The system of claim 14, wherein the substrate includes, metal oxides including at least one of zeolites and alumina beads, and polymeric materials including at least one of polyacrylate-polyalcohol beads, polydimethyl siloxane beads, poly (methyl methacrylate) microspheres (PMMA), divinyl benzene beads, and polyethylene glycol granular or polyethylene glycol (PEG).

16. The system of claim 1, wherein the filtering cartridge achieves separation and/or purging of the fluids using the chemisorption process by the filtering cartridge including an active molecule infused on the molecular filter to help with chemisorption reactions for separation of the gases, wherein the active molecule is adapted to undergo chemisorption with the emissions to enable recycling of un-adsorbed gas, and wherein the active molecule includes at least one of a thiosulphate, an oxidizer, phosphoric acid, ferrous sulphate, a metal hydroxide, an iodide, a bicarbonate, amines, and metal oxides.

17. The system of claim 1, wherein the substrate is filled into a spiral pipe running between the inlet and the outlet, wherein the spiral pipes allow a maximum flow path of the fluid for separation, and wherein the substrate is solid packed or lined liquid and porous matrices.

18. The system of claim 1, wherein the substrate is in the form of a block, and wherein the block is at least one of,
a block having a plurality of internal tortuous hollow paths configured there within, wherein each of the tortuous paths are shaped as longitudinal channels having different connected and staggered sections to form a plurality of parallel running gas flow paths, and wherein each staggered section is connected to a section preceding it and to a section succeeding it, and
a porous substrate block that has internal hollow channels to enable passage of gases therethrough, wherein the porous substrate block is adapted to be positioned within the hollow casing such that the internal hollow channels extend in the direction running from the inlet to the outlet such that gases entering through the inlet enter the internal hollow channels where the adsorption process happens as the gas moves towards the outlet.

19. The system of claim 1 wherein, the substrate includes a plurality of porous substrate blocks that are stacked over each other and adapted to be positioned in a stacked manner within the hollow casing, and wherein a gas flow path is configured by pores in each of the porous substrate blocks that interconnect once the blocks are stacked over each other extending between the inlet and the outlet of the hollow casing.

20. The system of claim 1 wherein, the substrate is configured in the form of a plurality of spherical beads that are filled in the hollow casing to extend between the inlet and the outlet, wherein the beads have a high surface area and include at least one of a ceramic and a carbon in different sizes to enhance packing density and functions for storage and separation of fluids.
